(19) United States
(12) Patent Application Publication
(10) Pub. No.: US 2014/0367143 A1
(43) Pub. Date: Dec. 18, 2014

(54) COAXIAL CABLE

(71) Applicant: Hitachi Metals, Ltd., Tokyo (JP)

(72) Inventors: Masahiro ABE, Hitachi (JP); Sohei KODAMA, Hitachi (JP); Akinari NAKAYAMA, Hitachinaka (JP)

(73) Assignee: Hitachi Metals, Ltd., Tokyo (JP)

(21) Appl. No.: 14/305,349

(22) Filed: Jun. 16, 2014

(30) Foreign Application Priority Data
Jun. 17, 2013 (JP) 2013-126476

(51) Int. Cl. H01B 11/18

(52) U.S. Cl. CPC H01B 11/1834
USPC 174/107

(57) ABSTRACT

A coaxial cable includes a center conductor, an insulating layer including a foam layer covering an outer periphery of the center conductor and a solid layer covering an outer periphery of the foam layer, and a protruding portion provided around an interface between the foam layer and the solid layer and in a longitudinal direction of the solid layer, to disperse external force.

The present application is based on Japanese patent application No. 2013-126476 filed on Jun. 17, 2013, the entire contents of which are incorporated herein by reference.

### BACKGROUND OF THE INVENTION

1. Field of the Invention

This invention relates to a coaxial cable.

2. Description of the Related Art

A coaxial cable, such as a high frequency coaxial cable or the like used in, e.g. a mobile communication facility or a microwave communication facility, is configured as including a center conductor (inner conductor), a foam layer which is formed as an insulating layer for covering an outer periphery of the center conductor, and an outer conductor for covering an outer periphery of the foam layer. Further, the coaxial cable is configured in such a manner that the center conductor, the foam layer, and the outer conductor are coaxially structured.

Generally, the outer conductor is corrugated to improve the flexibility of the coaxial cable. That is, after the outer conductor is covering the outer periphery of the foam layer, by using, e.g., an annular ring, and from the outer periphery of the outer conductor, a predetermined portion of the outer conductor is depressed and corrugated so that the outer conductor is formed with a root and a crest. At this point, in the portion where the outer conductor is pressed by the corrugation, the foam layer located around the inner periphery of the outer conductor is pressed as well. The foam layer is low in density. Therefore, when the foam layer has been pressed, the pressed portion of the foamed layer has collapsed, and the entire foam layer has deformed. Also, for example, when the coaxial cable has been installed in a narrow space, an external force such as bending force, etc. has been applied to the coaxial cable. In this case, the foam layer in the portion to which the external force has been applied also has collapsed, and the entire foam layer has deformed. When the foam layer has deformed in this way, the characteristic impedance of the coaxial cable has been outside a desired range (e.g. 50±2Ω). Since this coaxial cable has been a defective product, the productivity of the coaxial cable has lowered.

Accordingly, a coaxial cable comprising an insulating layer including a foam layer and a solid layer which is a non-foam layer, around an outer periphery of a center conductor, in order to suppress the deformation of the foam layer due to an external force acting thereon has been suggested (see, e.g. JP-A-2005-302412). That is, this coaxial cable has been configured so that the solid layer is formed between the foam layer and the outer conductor covering the outer periphery of the foam layer.

Refer to e.g. JP-A-2005-302412.

### SUMMARY OF THE INVENTION

By constituting the insulating layer from the foam layer and the solid layer, it is possible to suppress the deformation of the foam layer due to the external force applied to the coaxial cable. That is, by the solid layer being provided between the foam layer and the outer conductor, the deformation of the foam layer can be suppressed. However, when the insulating layer is constituted from the foam layer and the solid layer, the degree of foaming of the insulating layer is lowered, in comparison with when the insulating layer is constituted from only the foam layer. Incidentally, in the case where the insulating layer is constituted from the foam layer and the solid layer, the degree of foaming of the insulating layer is the degree of foaming when the foam layer and the solid layer are combined together. That is, when the thickness of the insulating layer is constant, and the degree of foaming of the foam layer is constant, and when the insulating layer is constituted from the foam layer and the solid layer, the degree of foaming of the insulating layer is lowered by the solid layer. When the degree of foaming of the insulating layer has been lowered, the dielectric loss of the coaxial cable has been significant, therefore increasing the cable loss.

Therefore, in order to increase the degree of foaming of the insulating layer, it is conceivable to increase the degree of foaming of the foam layer. However, when the degree of foaming of the foam layer has been high, the foam layer has had massive continuous bubbles (voids) caused therein. The coaxial cable with the voids caused in the foam layer has been a defective product since impedance anomaly (VSWR anomaly: Voltage Standing Wave Ratio anomaly) in the longitudinal direction has occurred. Further, in order to increase the degree of foaming of the insulating layer, it is conceivable to reduce the thickness of the solid layer. However, when the thickness of the solid layer has been reduced, the foam layer has deformed due to the external force being applied to the coaxial cable.

Accordingly, it is an object of the present invention to provide a coaxial cable, which overcomes the foregoing problem, and which is capable of suppressing the deformation of the foam layer.

(1) According to an embodiment of the invention, a coaxial cable comprises:

a center conductor;

an insulating layer comprising a foam layer covering an outer periphery of the center conductor, and a solid layer covering an outer periphery of the foam layer; and

a protruding portion for dispersing external force, the protruding portion being provided around an interface between the foam layer and the solid layer and in a longitudinal direction of the solid layer.

In the first embodiment, the following modifications and changes can be made.

(i) The insulating layer has a degree of foaming of not smaller than 70% and not greater than 80%.

(ii) The protruding portion has a thickness of a thinnest portion of not greater than 100 μm.

(iii) The protruding portion has an aspect ratio of not smaller than 0.5 and not greater than 1.5.

(iv) The protruding portion is provided linearly in the longitudinal direction of the solid layer.

(v) The protruding portion comprises two or more portions provided at a predetermined pitch in a circumferential direction of the solid layer.

(vi) A ratio of a width of each protruding portion and a distance between adjacent protruding portions is not smaller than 1:1.2 and not greater than 1:1.3, at a cross section in a direction perpendicular to the longitudinal direction of the solid layer.

(vii) A layer thickness ratio of a thinnest thickness of the solid layer and a thickest thickness of the solid layer is 1:2 to 1:4.

(Points of the Invention)

The coaxial cable according to the invention can suppress deformation of the foam layer.

### BRIEF DESCRIPTION OF THE DRAWINGS

The embodiment according to the invention will be explained below referring to the drawings, wherein:

FIG. 1 is a schematic perspective view showing a coaxial cable in one embodiment according to the present invention;

FIG. 2 is a schematic cross sectional view showing an insulating layer of the coaxial cable in one embodiment according to the present invention; and

FIG. 3 is a schematic cross sectional view showing one example of a cooling tube which is used in producing the coaxial cable in one embodiment according to the present invention.

### DETAILED DESCRIPTION OF THE PREFERRED EMBODIMENT

Next, one embodiment according to the invention will be described below in more detail in conjunction with the appended drawings.

(1) Configuration of the Coaxial Cable

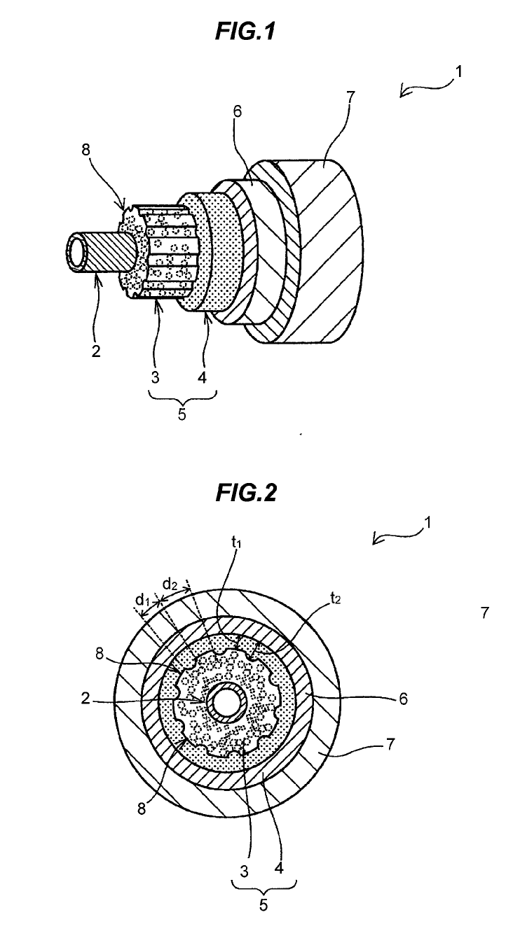

First, a configuration of a coaxial cable in one embodiment according to the present invention will be described mainly with reference to FIGS. 1 and 2.

As shown in FIG. 1, the coaxial cable 1 in the present embodiment is configured to include a center conductor (inner conductor) 2, an insulating layer 5 comprising a foam layer 3 and a solid layer 4, an outer conductor 6, and a sheath 7. That is, the coaxial cable 1 is configured in such a manner that the center conductor 2, the insulating layer 5, the outer conductor 6, and the sheath 7 are coaxially structured.

The center conductor 2 comprises an electricity or signal guiding material, e.g., copper or a copper alloy. As the center conductor 2, e.g., a copper material (copper pipe), which is molded in a hollow pipe shape, a copper material, which is molded in a rod shape, or the like may be used. Otherwise, as the center conductor 2, e.g., a lead wire, which is a copper or aluminum containing wire, a stranded wire, which comprises a plurality of wires twisted together, or the like may be used. Also, the center conductor 2 may be corrugated.

The insulating layer 5 is formed around an outer periphery of the center conductor 2 to cover the outer periphery of the central conductor 2. The insulating layer 5 is configured to include, in turn from the side of the center conductor 2, the foam layer 3 and the solid layer 4 which is a non-foam layer. The foam layer 3 is formed by foaming an insulating material extruded and coated around the outer periphery of the central conductor 2 using an extruder or the like. Also, the solid layer 4 is formed around the outer periphery of the foam layer 3, to cover the outer periphery of the foam layer 3. As shown in FIG. 2, a protruding portion 8 is provided around an interface between the foam layer 3 and the solid layer 4, i.e., around an inner surface of the solid layer 4. The protruding portion 8 is provided linearly in a longitudinal direction of the solid layer 4. Incidentally, a plurality of the protruding portions 8 may be provided at a predetermined pitch in the circumferential direction of the solid layer 4.

Thus, when an external force is applied to the coaxial cable 1, the external force acts on the insulating layer 5 (the foam layer 3 and the solid layer 4), and the external force acting on the foam layer 3 can be dispersed in various directions. That is, for example, when an external force acts on the insulating layer 5 due to corrugating the outer conductor 6 to be described later, or when the external force acts on the insulating layer 5 due to bending the coaxial cable 1, the external force acts on the foam layer 3 through the solid layer 4. At this point, the protruding portions 8 provided around the solid layer 4 allow the external force acting on the foam layer 3 to be dispersed in various directions. Therefore, when the external force acts on the foam layer 3, only mainly the protruding portions of the foam layer 3, i.e. mainly portions of the foam layer 3 which are located in recessed portions of the solid layer 4, are collapsed and deformed. In other words, it is possible to suppress the collapse of the entire foam layer 3 and the deformation of the entire foam layer 3. For example, the deformation rate of the foam layer 3 can be not greater than 10%.

Further, by providing the protruding portions 8 in this way and dispersing the external force acting on the foam layer 3 in various directions, it is possible to suppress the deformation of the foam layer 3 even when thinning the thickness of the solid layer 4. This allows the proportion of the solid layer 4 occupying the insulating layer 5 to be small. Therefore, it is possible to suppress a decrease of the degree of foaming of the insulating layer 5. In other words, the degree of foaming of the insulating layer 5 can be not smaller than 70% and not greater than 80%, preferably not smaller than 73% and not greater than 77%, more preferably 75%. It should be noted that the degree of foaming of the insulating layer 5 is the degree of foaming when the foam layer 3 and the solid layer 4 are combined together. Thus, for example, when the degree of foaming of the foam layer 3 is constant, the degree of foaming of the foam layer 5 can be increased in accordance with the decrease in thickness of the solid layer 4. This allows reducing the dielectric loss of the coaxial cable 1. If the degree of foaming of the insulating layer 5 is less than 70%, the dielectric loss of the coaxial cable 1 will be significant. Further, if the degree of foaming of the insulating layer 5 is more than 80%, it will be necessary to increase the degree of foaming of the constituent foam layer 3 of the insulating layer 5, and the foam layer 3 is likely to have voids therein.

The solid layer 4 may be not greater than 100 μm, preferably not smaller than 50 μm and not greater than 100 μm in a thickness of the thinnest portion (herein, also referred to as “thinnest thickness”) t₁. Incidentally, the thinnest thickness t₁ of the solid layer 4 is the thickness of portions excluding the protruding portions 8 of the solid layer 4, i.e., the thickness of the recessed portions of the solid layer 4. Accordingly, since the proportion of the solid layer 4 occupying the insulating layer 5 is small, it is possible to further reduce the degree of foaming of the insulating layer 5.

Further, the layer thickness ratio of the thinnest thickness t₁ of the solid layer 4 and a thickness of a thickest portion (herein, also referred to as “thickest thickness”) t₂ may be thinnest thickness t₁: thickest thickness t₂=1:2 to 1:4. Incidentally, the thickest thickness t₂ of the solid layer 4 is the thickness of the protruding portions 8 of the solid layer 4 and corresponds to the height of the protruding portions 8 of the solid layer 4. Thus, it is possible to further reduce the dielectric loss of the coaxial cable 1, while further suppressing the deformation of the foam layer 3. If the layer thickness ratio of the thinnest thickness t₁ and the thickest thickness t₂ is less than 1:2, the thickness of the protruding portions 8 is thin, i.e., the height of the protruding portions 8 is low, therefore leading to lowering the effect of dispersing the external force acting on the foam layer 3. Therefore, the foam layer 3 is likely to deform. Further, if the layer thickness ratio of the thinnest thickness t₁ and the thickest thickness t₂ is more than 1:4, the thickness of the protruding portions 8 is thick, i.e., the height of the protruding portions 8 is high, therefore leading to the proportion of the solid layer 4 occupying the insulating layer 5 being large, therefore lowering the degree of foaming of the insulating layer 5, and being not likely to increase the dielectric loss of the coaxial cable 1.

The protruding portions 8 may be formed, so that the aspect ratio (height of the protruding portions 8/width of the protruding portions 8) is not smaller than 0.5 and not greater than 1.5, preferably not smaller than 0.5 and not greater than 1.0. Thus, it is possible to further reduce the dielectric loss of the coaxial cable 1, while further suppressing the deformation of the foam layer 3 due to the external force acting thereon. Because if the aspect ratio is less than 0.5, the height of the protruding portion 8 will be low and the effect of dispersing the external force acting on the foam layer 3 lowers. Therefore, the foam layer 3 is likely to deform. Further, if the aspect ratio is more than 1.5, the height of the protruding portions 8 will be too high, therefore leading to the proportion of the solid layer 4 occupying the insulating layer 5 being large. That is, the proportion of the foam layer 3 occupying the insulating layer 5 is small. Therefore, the degree of foaming of the insulating layer 5 is likely to lower (is likely to be less than 70% e.g.), and the dielectric loss of the coaxial cable 1 is likely to increase.

The solid layer 4 may have a ratio of a width d₁ of the protruding portions 8 and a distance d₂ between the adjacent protruding portions 8 and 8 of not smaller than 1:1.2 and not greater than 1:1.3, at a cross section in a direction perpendicular to the longitudinal direction of the solid layer 4. As a result, it is possible to suppress the deformation of the foam layer 3 due to the external force acting thereon. Since if the ratio of the width d₁ of the protruding portions 8 and the distance d₂ between the adjacent protruding portions 8 and 8 is less than 1:1.2, the distance d₂ between the adjacent protruding portions 8 and 8 is too short, the effect of dispersing the external force is likely to lower, and the proportion of the solid layer 4 occupying the insulating layer 5 is large, and the degree of foaming of the insulating layer 5 is likely to be high. In addition, if the ratio of the width d₁ of the protruding portions 8 and the distance d₂ between the adjacent protruding portions 8 and 8 exceeds 1:1.3, the distance d₂ between the adjacent protruding portions 8 and 8 will be long and the effect of dispersing the external force will lower.

The solid layer 4 is formed by e.g. extrusion coating of a predetermined material with an extruder. As a material for forming the solid layer 4, a resin having a viscosity greater than a viscosity of a material which forms the foam layer 3 may be used. As the material for forming the solid layer 4, it is possible to use, e.g., a polyolefin based resin or the like. That is, polyethylenes of each type, such as LDPE (low density polyethylene), HDPE (high density polyethylene), LLDPE (linear low density polyethylene), MDPE (medium density polyethylene), UHMWPE (ultra high molecular weight polyethylene) or the like may be used singly or in mixture.

In addition, the degree of foaming of the foam layer 3 may be, e.g., not smaller than 70% and not greater than 80%. This allows the degree of foaming of the insulating layer 5 to be likely to be not smaller than 70% and not greater than 80%, making it possible to further reduce the dielectric loss of the coaxial cable 1. Incidentally, if the degree of foaming of the foam layer 3 is less than 70%, the dielectric loss of the coaxial cable 1 will be significant. Further, if the degree of foaming of the foam layer 3 is more than 80%, the foam layer 3 will be likely to have voids therein.

The insulating foam 3 is formed by, e.g., foaming an insulating material having a low dielectric constant. As this insulating material, e.g. a polyolefin based resin may be used. As the polyolefin based resin, polyethylene, polypropylene, ethylene-propylene copolymer, block polypropylene, random polypropylene, implantable TPO, ethylene-propylene-butene copolymers, ethylene-butene copolymers, ethylene-octene copolymers, ethylene-hexene copolymers, and ethylene-pentene copolymers may be used. As the polyethylene, polyethylenes of each type, such as LDPE (low density polyethylene), HDPE (high density polyethylene), LLDPE (linear low density polyethylene), MDPE (medium density polyethylene), UHMWPE (ultra high molecular weight polyethylene), etc. may be used singly or in mixture. For example, as the insulating material, the MDPE and the LDPE may be used by being mixed at a ratio of 70/30 to 90/10.

As a method for foaming the insulating material, there are a physically foaming method (physical foaming) and a chemically foaming method (chemical foaming). The physical foaming is a foaming method by, e.g. injecting (press-fitting) a foaming gas into an insulating material in an extruder under a high pressure greater than atmospheric pressure, dissolving the foaming gas in the insulating material, and thereafter releasing this insulating material under atmospheric pressure. As the foaming gas, e.g. an inert gas such as carbon dioxide (CO₂) gas, nitrogen (N₂) gas, argon (Ar) gas or the like may be used. At this point, the injection pressure of the foaming gas can appropriately be adjusted according to degree of foaming of the foam layer 3, type of the insulating material, and the like. Further, when the insulating material is physically foamed, a foam nucleating agent may be added to the insulating material. The chemical foaming is a foaming method by mixing and dispersing a chemically foaming agent in an insulating material with an extruder, and heating the chemically foaming agent dispersed in the insulating material during kneading to a temperature higher than a decomposition temperature of the chemically foaming agent to cause a decomposition reaction of the chemically foaming agent, and use a gas produced by the decomposition of the chemically foaming agent. Incidentally, the chemically foaming agent is not particularly limited, but various known chemically foaming agents may be used.

In the insulating material which constitutes the foam layer 3, besides the foaming agent (chemically foaming agent), e.g., an antioxidant, a viscosity modifier, a thickener, a reinforcing agent, a filler, a plasticizer (softener), a vulcanizing agent, a vulcanization accelerator, a crosslinking agent, a crosslinking aid, a foaming aid, a processing aid, an anti-aging agent, a heat stabilizer, a weathering stabilizer, an antistatic agent, a lubricant, other additives, etc. may be added.

The outer conductor 6 covering the outer surface of the solid layer 4 is provided around an outer periphery of the insulating layer 5, i.e., around an outer periphery of the solid layer 4, there is provided. As the outer conductor 6, e.g., a copper material (copper pipe) which is molded in a cylindrical shape may be used. It should be noted that the outer conductor 6 may be corrugated. Thus, it is possible to further enhance the flexibility of the coaxial cable 1.

The sheath (outer cover) 7 covering the outer surface of the outer conductor 6 is provided around an outer periphery of the outer conductor 6. The sheath 7 is formed by, e.g., extrusion molding a resin such as polyethylene (PE), ethylene-vinyl acetate copolymer (EVA), polyurethane or the like.

(2) Production Method of the Coaxial Cable

Subsequently, a method for producing the coaxial cable 1 in one embodiment according to the present invention will be described.

(Center Conductor Forming Step)

First, as the center conductor 2, e.g., a copper material (copper pipe) which is molded in a pipe shape is prepared. Then, the center conductor 2 is corrugated to be formed with a crest and a root. It should be noted, however, that the center conductor 2 may be not corrugated.

(Insulating Layer Forming Step)

After the center conductor forming step is completed, the insulating layer 5 is formed by, in turn from the side of the center conductor 2, forming the foam layer 3 and the solid layer 4 covering the outer periphery of the central conductor 2.

(Insulation Foam Forming Step)

The foam layer 3 is first formed by, e.g. using an extruder or the like, extrusion coating an insulating material for forming the foam layer 3 covering the outer periphery of the center conductor 2. For example, first, the extruder is adjusted so that pressure therein is a high pressure above atmospheric pressure, and under this high pressure, a foaming gas is injected into the insulating material in the extruder. Thus, the foaming gas is dissolved in the insulating material. Then, while the foaming gas is being injected into the insulating material, the insulating material with the foaming gas dissolved therein is extruded and coated covering the outer periphery of the center conductor 2 delivered from, e.g. a feeder or the like. A gas is produced by the foaming gas dissolved in the insulating material being supersaturated when the insulating material extruded and coated around the outer periphery of the central conductor 2 is released from under the high pressure to the atmospheric pressure. Accordingly, the insulating material is foamed to form the foam layer 3.

(Solid Layer Forming Step)

After the foam layer forming step is completed, the solid layer 4 is formed by, e.g. using an extruder or the like, extrusion coating a material for forming the solid layer 4 covering the outer periphery of the foam layer 3. After that, e.g., the central conductor 2 formed with the foam layer 3 and the solid layer 4 is passed through inside a cooling tube (sizing die) 9, and the outer diameter of the solid layer 4 is thereby trimmed, and the foam layer 3 and the solid layer 4 are cooled and solidified. Thus, the insulating layer 5 is formed.

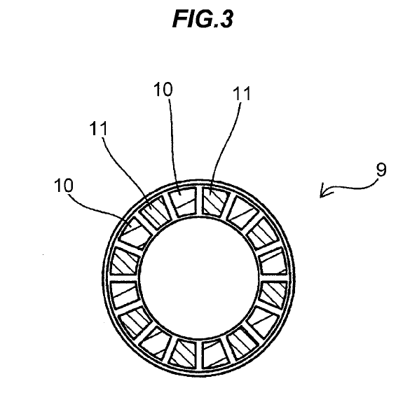

For example, as shown in FIG. 3, the cooling tube 9 may be provided with a water passage 10 through which water at a predetermined temperature (e.g. about 10 degrees Celsius to 15 degrees Celsius) is passed, and a heated water passage 11 through which heated water at a predetermined temperature (e.g. about 40 degrees Celsius to 50 degrees Celsius) is passed, alternately in a circumferential direction of the cooling tube 9. At this point, a thermally insulating material may be provided between the water passage 10 and the heated water passage 11. Thus, it is possible to vary the cooling rate in the circumferential direction of the cooling tube 9. This can result in the protruding portions 8 being formed around the interface between the foam layer 3 and the solid layer 4 (i.e. the inner surface of the solid layer 4).

That is, when the central conductor 2 formed with the foam layer 3 and the solid layer 4 is passed through inside the cooling tube 9 provided with the water passage 10 and the heated water passage 11 alternately, the solid layer 4 which is passed through the portion provided with the water passage 10 is cooled and solidified faster than the solid layer 4 which is passed through the portion provided with the heated water passage 11. That is, the solid layer 4 which is passed through the portion provided with the heated water passage 11 has a slower solidification rate than the solid layer 4 which is passed through the portion provided with the water passage 10. Accordingly, the solid layer 4 which is passed through the portion provided with the heated water passage 11 is tensioned in the circumferential direction toward the portion provided with the heated water passage 11. At this point, the outer periphery of the solid layer 4 is in contact with the inner periphery of the cooling tube 9. Therefore, when the solid layer 4 which is passed through the portion provided with the heated water passage 11 is tensioned in the circumferential direction toward the portion provided with the heated water passage 11, the solid layer 4 which is passed through the portion provided with the heated water passage 11 is tensioned to the inner circumferential side of the solid layer 4. This can result in the protruding portions 8 being formed around the inner surface of the solid layer 4. Incidentally, by changing each of the temperature of the heated water flowing in the heated water passage 11, the respective widths of the water passage 10 and the heated water passage 11, it is possible to adjust each of the thinnest thickness t₁ and the thickest thickness t₂ of the solid layer 4, the width d₁ of the protruding portions 8, the distance d₂ between the adjacent protruding portions 8 and 8, and the aspect ratio.

(Outer Conductor Forming Step)

Subsequently, the outer conductor 6 is provided to cover the outer periphery of the insulating layer 5 and to be structured coaxially with the center conductor 2 and the insulating layer 5. As the outer conductor 6, e.g. a copper material (copper pipe) formed in a cylindrical shape may be used. Then, by using, e.g., an annular ring, around the outer conductor 6, a predetermined portion of the outer conductor 6 is depressed and corrugated so that the outer conductor 6 is formed with a root and a crest. It should be noted, however, that the outer conductor 6 may be not corrugated.

(Sheath Formation Process)

The sheath 7 is formed by, e.g. extrusion molding a resin such as polyethylene (PE) or the like, to cover the outer periphery of the outer conductor 6, resulting in the coaxial cable 1. This results in the production process of the coaxial cable 1 of the present embodiment being ended.

(3) Effects of the Present Embodiment

The present embodiment has one or more effects described below.

(a) In the present embodiment, the insulating layer 5 including, in turn from the side of the center conductor 2, the foam layer 3 and the solid layer 4, is covering the outer periphery of the central conductor 2. Then, around the interface between the foam layer 3 and the solid layer 4, the protruding portions 8 are provided in the longitudinal direction of the solid layer 4. By providing the protruding portions 8 in this manner, it is possible to disperse in various directions external force acting on the foam layer 3 due to the external force being applied to the coaxial cable 1. Therefore, it is possible to suppress the collapse of the foam layer 3 and the deformation of the entire foam layer 3. That is, even when an external force acts on the foam layer 3, it is possible to collapse only mainly the protruding portions of the foam layer 3, i.e. mainly the portions of the foam layer 3 which are located in the recessed portions of the solid layer 4.

(b) In the present embodiment, as described above, by providing the protruding portions 8 around the interface between the foam layer 3 and the solid layer 4 and in the longitudinal direction of the solid layer 4, the external force acting on the foam layer 3 is dispersed in various directions. Thus, it is possible to suppress the deformation of the foam layer 3 even when thinning the thickness of the solid layer 4. Therefore, the proportion of the solid layer 4 occupying the insulating layer 5 can be small, making it possible to suppress a decrease in the degree of foaming of the insulating layer 5. That is, the degree of foaming of the insulating layer 5 can be not smaller than 70% and not greater than 80%. Consequently, it is possible to reduce the dielectric loss of the coaxial cable 1.

(c) In the present embodiment, the protruding portions 8 have the aspect ratio of not smaller than 0.5 and not greater than 1.5. Thus, it is possible to fluffier reduce the dielectric loss of the coaxial cable 1, while further suppressing the deformation of the foam layer 3 due to an external force acting thereon. That is, when an external force is applied to the coaxial cable 1, it is possible to suppress the deformation of the foam layer 3 by dispersing the external force, it is possible to suppress the decrease in the degree of foaming of the insulating layer 5 due to the proportion of the solid layer 4 occupying the insulating layer 5 being small, and it is possible to further reduce the dielectric loss of the coaxial cable 1.

(d) In the present embodiment, the protruding portions 8 have the thickness of the thinnest portion of not greater than 100 μm. Accordingly, since the proportion of the solid layer 4 occupying the insulating layer 5 is small, it is possible to further reduce the degree of foaming of the insulating layer 5. Therefore, it is possible to further reduce the dielectric loss of the coaxial cable 1.

### Another Embodiment According to the Present Invention

Although one embodiment according to the present invention has been explained in detail, the present invention is not intended to be limited to the embodiment described above, but appropriate modifications may be made without departing from the spirit thereof.

Although in the above embodiment, it has been described that the protruding portions 8 are provided linearly in the longitudinal direction of the solid layer 4, but it is not limited thereto. For example, the protruding portions 8 may be provided in a waved shape around the inner surface of the solid layer 4. Also, for example, the protruding portions 8 may be provided in a spiral shape with a central axis of the solid layer 4 around the inner surface of the solid layer 4.

### EXAMPLES

The following describes Examples of the present invention, but the present invention is not limited to these Examples.

### Example 1

In Example 1, as the center conductor, a copper material (copper pipe) formed into a hollow pipe shape and having a diameter of 13.51 nm was used.

Then, first, an extruder was adjusted so that pressure therein was a high pressure above atmospheric pressure, and under this high pressure, a predetermined amount of foaming gas was injected into an insulating material in the extruder, and the foaming gas was dissolved in the insulating material. Then, while the foaming gas was injected into the insulating material, the insulating material with the foaming gas dissolved therein was extruded and coated to cover the outer periphery of the center conductor. Thereafter, the insulating material was foamed with the foaming gas dissolved in the insulating material, by releasing the insulating material extruded and coated around the outer periphery of the central conductor from under the high pressure to the atmospheric pressure. This resulted in a foam layer having a degree of foaming of 76.35%.

Next, a material to form the solid layer was extruded and coated around the outer periphery of the foam layer by using an extruder, resulting in the solid layer. Thereafter, the central conductor formed with the foam layer and the solid layer was passed through inside a cooling tube having a diameter of the inner periphery of 33.5 mm provided with a water passage through which water has been passed, and a heated water passage through which heated water has been passed, alternately in the circumferential direction of the cooling tube. At this point, water at 10 degrees Celsius was passed through the water passage, while heated water at 50 degrees Celsius was passed through the heated water passage, so that the thinnest thickness t₁ of the solid layer was 50 μm and the thickest thickness t₂ of the solid layer was 200 μm. Thus, while a protruding portion having an aspect ratio of 0.5 was formed around the inner surface of the solid layer, the foam layer and the solid layer were cooled and solidified. This resulted in an insulating layer having an outer diameter of 33.5 mm and a degree of foaming of 75%. Then, the center conductor was removed from the insulating layer, resulting in a specimen of the insulating layer in Example 1 from which the center conductor was removed.

### Example 2

In Example 2, by adjusting the amount of the foaming gas to be injected into the insulating material to form a foam layer in an extruder, the foam layer having a degree of foaming of 75.81% was formed. Water at 30 degrees Celsius was passed through the water passage, while heated water at 50 degrees Celsius was passed through the heated water passage, so that the thinnest thickness t₁ of the solid layer was 50 μm and the thickest thickness t₂ of the solid layer was 200 μm. Thus, a protruding portion having an aspect ratio of 1 was formed around the inner surface of the solid layer. Besides, in the same manner as in Example 1 described above, an insulating layer was formed around the outer periphery of the central conductor. Then, the center conductor was removed from the insulating layer, resulting in a specimen of the insulating layer in Example 2 from which the center conductor is removed.

### Example 3

In Example 3, by adjusting the amount of the foaming gas to be injected into the insulating material to form a foam layer in an extruder, the foam layer having a degree of foaming of 75.74% was formed. Water at 10 degrees Celsius was passed through the water passage, while heated water at 50 degrees Celsius was passed through the heated water passage, so that the thinnest thickness t₁ of the solid layer was 50 μm and the thickest thickness t₂ of the solid layer was 200 μm. Thus, a protruding portion having an aspect ratio of 0.25 was formed around the inner surface of the solid layer. Besides, in the same manner as in Example 1 described above, an insulating layer was formed around the outer periphery of the central conductor. Then, the center conductor was removed from the insulating layer, resulting in a specimen of the insulating layer in Example 3 from which the center conductor was removed.

### Example 4

In Example 4, by adjusting the amount of the foaming gas to be injected into the insulating material to form a foam layer in an extruder, the foam layer having a degree of foaming of 76.8% was formed. Water at 10 degrees Celsius was passed through the water passage, while heated water at 50 degrees Celsius was passed through the heated water passage, so that the thinnest thickness t₁ of the solid layer was 50 μm and the thickest thickness t₂ of the solid layer was 200 μm. Thus, a protruding portion having an aspect ratio of 2 was formed around the inner surface of the solid layer. Besides, in the same manner as in Example 1 described above, an insulating layer was formed around the outer periphery of the central conductor. Then, the center conductor was removed from the insulating layer, resulting in a specimen of the insulating layer in Example 4 from which the center conductor was removed.

### Comparative Example 1

In Comparative example 1, by adjusting the amount of the foaming gas to be injected into the insulating material to form a foam layer in an extruder, the foam layer having a degree of foaming of 75% was formed around the outer periphery of the central conductor. Thereafter, the central conductor formed with the foam layer was passed through inside a cooling tube having a diameter of the inner periphery of 33.5 mm, so that the foam layer was cooled and solidified. At this point, the cooling tube was used that causes no temperature difference in the circumferential direction, i.e., a cooling rate of which was uniform in the circumferential direction. Besides, in the same manner as in Example 1 described above, an insulating layer was formed around the outer periphery of the central conductor. Then, the center conductor was removed from the insulating layer, resulting in a specimen of the insulating layer in Comparative example 1 from which the center conductor was removed.

### Comparative Example 2

In Comparative example 2, by adjusting the amount of the foaming gas to be injected into the insulating material to form a foam layer in an extruder, the foam layer having a degree of foaming of 77.19% was formed around the outer periphery of the central conductor. And a solid layer having a thickness of 200 μm was formed around the outer periphery of the foam layer. At this point, the cooling tube was used that caused no temperature difference in the circumferential direction, i.e., a cooling rate of which was uniform in the circumferential direction. This resulted in an insulating layer having the foam layer and the solid layer with no protruding portion formed therearound being formed around the outer periphery of the central conductor. Then, the center conductor was removed from the insulating layer, resulting in a specimen of the insulating layer in Comparative example 2 from which the center conductor was removed.

### Comparative Example 3

In Comparative example 3, by adjusting the amount of the foaming gas to be injected into the insulating material to form a foam layer in an extruder, the foam layer having a degree of foaming of 75.54% was formed around the outer periphery of the central conductor. And a solid layer having a thickness of 50 μm was formed around the outer periphery of the foam layer. Besides, in the same manner as in Comparative example 2, an insulating layer having the foam layer and the solid layer with no protruding portion formed therearound was formed around the outer periphery of the central conductor. Then, the center conductor was removed from the insulating layer, resulting in a specimen of the insulating layer in Comparative example 3 from which the center conductor was removed.

For each specimen of these Examples 1 to 4 and Comparative examples 1 to 3, the deformation rate was measured and evaluated. The measurement of the deformation rate was carried out by the method described below. That is, first, a respective 50 mm long sample was cut out from each specimen of Examples 1 to 4 and Comparative examples 1 to 3. Then, each sample cut out from each specimen was wound with a 25 mm wide copper tape once therearound. Then, the tensile testing was performed by fixing one end of the copper tape and pulling the other end thereof with a force of 250 N. Then, a cross-sectional area of each sample before performing the tensile testing, and a cross-sectional area of each sample after performing the tensile testing were measured, and the deformation ratio was calculated from Formula 1 below. It should be noted that in the present examples, it is determined that the deformation of the foam layer is suppressed when the deformation rate is not greater than 10%.

Deformation ratio (%)=((cross-sectional area of the sample before tensile testing−cross-sectional area of the sample after tensile testing)/cross-sectional area of the sample before tensile testing)×100 (Formula 1)

The measurement is made for each specimen of Examples 1 to 4 and Comparative examples 1 to 3. The measured results of the deformation ratio are shown together in Table 1.

TABLE 1

| | Solid layer | | | | | |
|---|---|---|---|---|---|---|
| | Thin- | Thick- | | Degree of | Degree of | |
| | nest | est | | foaming | foaming | Defor- |
| | thick- | thick- | | of foam | of insulat- | mation |
| | ness | ness | Aspect | layer | ing layer | rate |
| | (μm) | (μm) | ratio | (%) | (%) | (%) |
| Example 1 | 50 | 200 | 0.5 | 76.35 | 75 | 7 |
| Example 2 | 100 | 200 | 1 | 75.81 | 75 | 5 |
| Example 3 | 50 | 200 | 0.25 | 75.74 | 75 | 8 |
| Example 4 | 50 | 200 | 2 | 76.8 | 75 | 3 |
| Comparative | — | — | — | 75 | 75 | 10 or |
| example 1 | | | | | | more |
| Comparative | — | 200 | — | 77.19 | 75 | 3 |
| example 2 | | | | | | |
| Comparative | — | 50 | — | 75.54 | 75 | 10 or |
| example 3 | | | | | | more |

From Table 1, from each specimen of Examples 1 to 4, it was confirmed that when the solid layer is provided with the protruding portion, even when the thinnest thickness of the solid layer is not greater than 100 μm, it is possible to suppress the deformation of the foam layer. That is, it was confirmed that since the external force acting on the foam layer is dispersed by the protruding portion, it is possible to suppress the deformation of the foam layer. In addition, it was confirmed that the degree of foaming of the foam layer can be 75.74% to 76.8%, and that the degree of foaming of the insulating layer can be 75%. That is, it was confirmed that it is possible to reduce the degree of foaming of the foam layer to the same order as the degree of foaming of the foam layer of Comparative example 1 in which the insulating layer is constituted from only the foam layer and is formed with no solid layer. Incidentally, from Comparative example 2, it is found that when the solid layer is provided with no protruding portion, reducing the deformation rate to not greater than 10% requires the thickness of the solid layer to be 200 μm. Therefore, it was confirmed that, in order for the degree of foaming of the insulating layer to be 75%, the degree of foaming of the foam layer is required to be 77.19%. It was confirmed that when the degree of foaming of the foam layer is high, the foam layer has voids caused therein. Further, from Comparative example 3, it was confirmed that when the solid layer is provided with no protruding portion, when the thickness of the solid layer (i.e., the thinnest thickness of the solid layer) is set at not greater than 100 μm, i.e., when it is set at 50 μm, the deformation rate of the foam layer is higher than 10%.

Further, from Examples 1 and 2, it was confirmed that when the aspect ratio of the protruding portion is 0.5 to 1.5, it is possible to further lower the deformation rate of the foam layer to be as low as not greater than 7%, and that the foam layer has no void caused therein. In addition, Example 4 allowed the deformation rate of the foam layer to be as low as 3%, but caused voids in the foam layer.

From the above results, it was confirmed that when the insulating layer is constituted from the foam layer and the solid layer, and when the inner surface of the solid layer is provided with the protruding portion in the longitudinal direction of the solid layer, since an external force acting on the foam layer is dispersed by the protruding portion, it is possible to suppress the deformation of the foam layer. Further, it was confirmed that since it is possible to reduce the thickness thinnest of the solid layer, it is possible to reduce the proportion of the solid layer occupying the insulating layer, and it is therefore possible to prevent the degree of foaming of the foam layer from being high. As a result, the coaxial cable, which is formed with that insulating layer, reduces the dielectric loss.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A coaxial cable, comprising:
a center conductor;
an insulating layer comprising a foam layer covering an outer periphery of the center conductor and a solid layer covering an outer periphery of the foam layer; and
a protruding portion for dispersing external force, the protruding portion being provided around an interface between the foam layer and the solid layer and in a longitudinal direction of the solid layer.

2. The coaxial cable according to claim 1, wherein the insulating layer has a degree of foaming of not smaller than 70% and not greater than 80%.

3. The coaxial cable according to claim 1, wherein the protruding portion has a thickness of a thinnest portion of not greater than 100 μm.

4. The coaxial cable according to claim 1, wherein the protruding portion has an aspect ratio of not smaller than 0.5 and not greater than 1.5.

5. The coaxial cable according to claim 1, wherein the protruding portion is provided linearly in the longitudinal direction of the solid layer.

6. The coaxial cable according to claim 1, wherein the protruding portion comprises two or more portions provided at a predetermined pitch in a circumferential direction of the solid layer.

7. The coaxial cable according to claim 6, wherein a ratio of a width of each protruding portion and a distance between adjacent protruding portions is not smaller than 1:1.2 and not greater than 1:1.3, at a cross section in a direction perpendicular to the longitudinal direction of the solid layer.

8. The coaxial cable according to claim 1, wherein a layer thickness ratio of a thinnest thickness of the solid layer and a thickest thickness of the solid layer is 1:2 to 1:4.
